(19) United States
(12) Patent Application Publication
(10) Pub. No.: US 2014/0143441 A1
(43) Pub. Date: May 22, 2014

(54) CHIP MULTI PROCESSOR AND ROUTER FOR CHIP MULTI PROCESSOR

(71) Applicant: Woong Seo, Hwaseong-si (KR)

(72) Inventor: Woong Seo, Hwaseong-si (KR)

(73) Assignee: SAMSUNG ELECTRONICS CO., LTD., Suwon-si (KR)

(21) Appl. No.: 13/680,014

(22) Filed: Nov. 17, 2012

(51) Int. Cl. H04L 12/56

(52) U.S. Cl. CPC H04L 45/00
USPC 709/238

(57) ABSTRACT

Provided is a chip multi processor that supports both a packet switching method and a circuit switching method, and a router for the chip multi processor. According to an aspect, the chip multi processor includes a plurality of nodes that each include a router, and a plurality of links formed between the routers. Each of the routers may transfer a first type of data based on packet switching and a second type of data based on circuit switching.

### CROSS-REFERENCE TO RELATED APPLICATION

This application claims the benefit under 35 USC §119(a) of a Korean Patent Application No. 10-2011-0133198, filed on Dec. 12, 2011, in the Korean Intellectual Property Office, the entire disclosure of which is incorporated herein by reference for all purposes.

### BACKGROUND

1. Field

The following description relates to a chip multi processor including a plurality of processors and a data communication technique for the chip multi processor.

2. Description of the Related Art

is Conventional processors include single core processors. Enhancing the performance of a single-core processor is dependent on increasing a clock speed, however, increasing the clock speed typically results in an increase in power consumption and excess generation of heat. For these reasons, there was limitation in enhancing the performance of a single-core processor.

In order to overcome the disadvantage of the single-core processor, a multi-core processor with a plurality of processing cores has been developed. The processing cores of a multi-core processor typically operate at a low frequency and consume power distributively. A multi-core processor can process a task in less time than a single-core processor. Accordingly, a multi-core processor may be more suitable for various applications including video encoding, PHOTOSHOP®, high-end games, and the like.

The performance of a multi-core processor is influenced by a network bandwidth between the processing cores. The network bandwidth may be enhanced by increasing the bandwidth of a network channel, that is, by increasing physical connection wires. However, the increase of a channel bandwidth also increases power consumption and cost.

### SUMMARY

In an aspect, there is provided a chip multi processor including a plurality of nodes each comprising at least one of a processor and a memory, a plurality of routers respectively connected to the plurality of nodes, and a plurality of links formed between the routers, wherein each router transfers a first type of data based on packet switching and a second type of data based on circuit switching.

Each node may differentiate a value written in a specific area of data based on a request from an application or based on a characteristic of the application, to create the first type of data or the second type of data.

In response to transferring the second type of data, the plurality of routers may establish a path between a source node that has generated the second type of data and a destination node that receives the second type of data, as a dedicated path for the second type of data.

Each router may comprise a first buffer configured to store the first type of data, a second buffer configured to store the second type of data, an output port determining unit configured to determine an output port through which the first type of data or the second type of data is to be output, a switch unit configured to transfer the first type of data or the second type of data stored in the first buffer or the second buffer to the determined output port, and a switch controller configured to establish a link connected to the determined output port as a dedicated link for the second type of data.

Each router may further comprise a receiver configured to determine whether received data is the first type of data or the second type of data, to transfer the first type of data to the first buffer, and to transfer the second type of data to the second buffer.

The output unit may comprise a crossbar switch.

In response to the determined output port being connected to a destination node for the second type of data, the controller may generate a predetermined dedicated path setup success message.

In response to the link connected to the determined output port already being allocated to another second type of data, the controller may generate a predetermined dedicated path setup failure message or a standby message.

In an aspect, there is provided a router for a chip multi processor, the router including a first buffer configured to store a first type of data, a second buffer configured to store a second type of data, an output port determining unit configured to determine an output port through which the first type of data or the second type of data is to be output, an output unit configured to output the first type of data or the second type of data to the determined output port, and a controller configured to establish a dedicated link connected to the determined output port for the second type of data.

The router may further comprise a receiver configured to determine whether the received data is the first type of data or the second type of data, to transfer the first type of data to the first buffer, and to transfer the second type of data to the second buffer.

The output unit may include a crossbar switch.

In response to the determined output port being connected to a destination node of the second type of data, the controller may generate a predetermined dedicated path setup success message.

In response to a link connected to the determined output port already being allocated to another second type of data, the controller may generate a predetermined dedicated path setup failure message or a standby message.

The first type of data may correspond to a message that is transferred based on packet switching, and the message may include a plurality of packets each having header information and which are capable of being transferred independently.

The second type of data may correspond to a message that is transferred based on circuit switching, and the message may have a single packet with header information.

In an aspect, there is provided a chip multiprocessor, including a plurality of processing nodes configured to process data, a plurality of routers configured to route data between the plurality of processing nodes during processing, wherein one or more of the plurality of routers selectively configure as a packet switching network and as a circuit switching network, based on the type of data to be routed.

In response to a first type of data being processed, the plurality of routers may configure as the packet switching network in which a path between a source router and a destination router is shared during transmission of the first type of data between the source router and the destination router.

In response to a second type of data being processed, the plurality of routers may configure as the circuit switching network in which a path between a source router and a destination router is not shared during transmission of the second type of data between the source router and the destination router.

The second type of data may correspond to an application that requests real-time processing.

Other features and aspects will be apparent from the following detailed description, the drawings, and the claims.

### BRIEF DESCRIPTION OF THE DRAWINGS

FIG. 1 is a diagram illustrating an example of a chip multi processor.

FIG. 2 is a diagram illustrating an example of a first type of data.

FIG. 3 is a diagram illustrating an example of a second type of data

FIG. 4 is a diagram illustrating an example of a router.

FIG. 5 is a flowchart illustrating an example of a routing method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

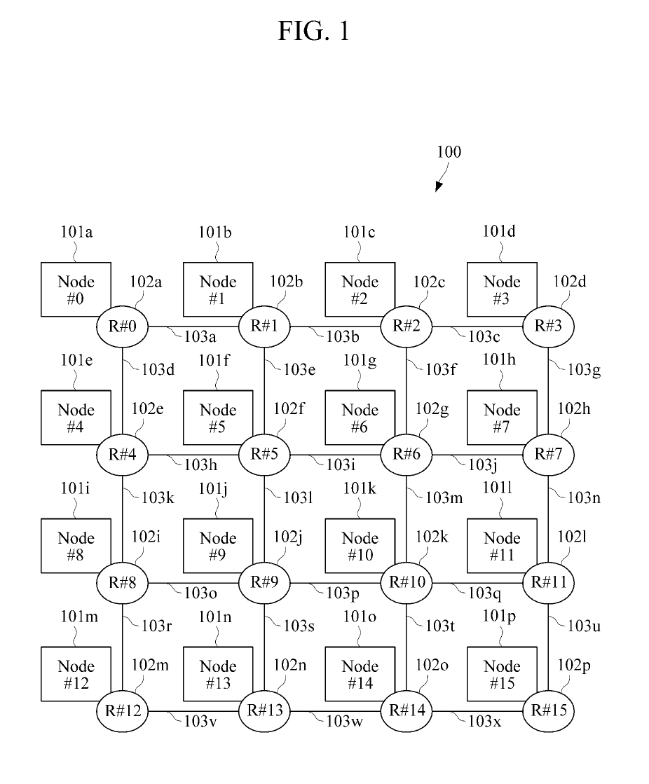

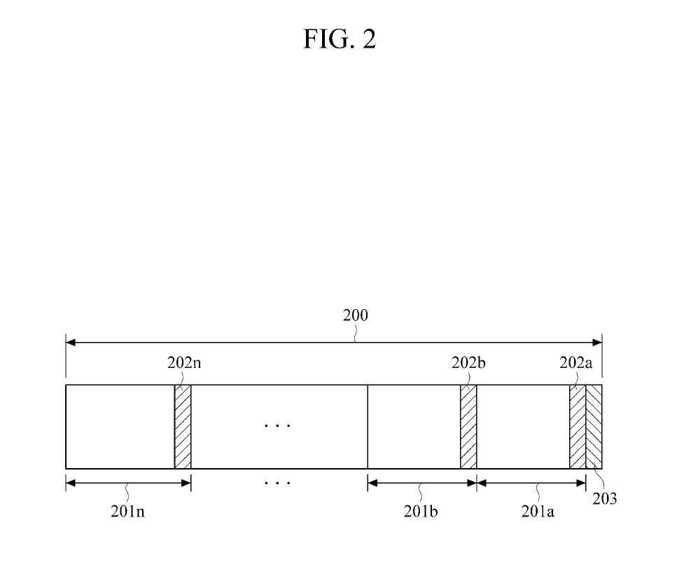

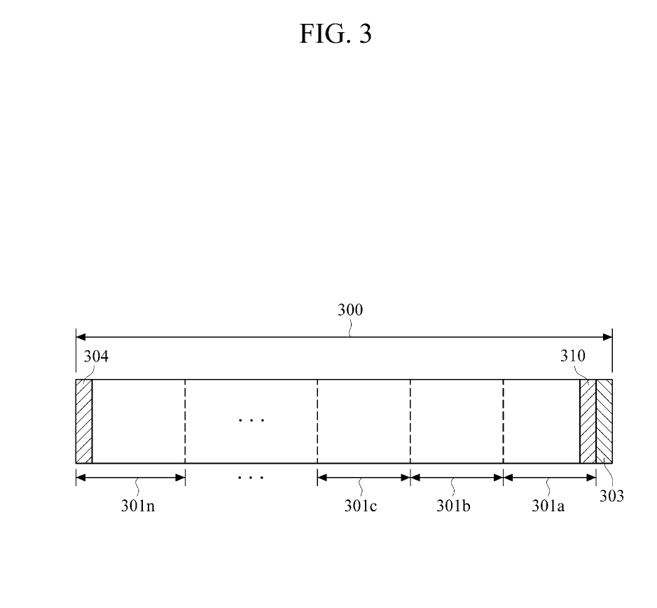

FIG. 1 illustrates an example of a chip multi processor (CMP), FIG. 2 illustrates an example of a first type of data, and FIG. 3 illustrates an example of a second type of data. The CMP may be included in a terminal, for example, a computer, a server, a mobile phone, a tablet, an appliance, a television, and the like.

Referring to FIG. 1, chip multi processor (CMP) 100 includes a plurality of nodes 101a through 101p and a plurality of routers 102a through 102p that are respectively connected to the nodes 101a through 101p. The CMP 100 also includes a plurality of connection links 103a through 103x that are formed between the routers 102a through 102p.

Each of the nodes 101a through 101p may process an operation or a task independently. For example, nodes #0 and #1 (101a and 101b) may simultaneously process multiple tasks that are not dependent on each other.

Each of the nodes 101a through 101p may include a processor and/or a memory. The nodes 101a through 101p may receive/transfer data from/to each other through a predetermined network that consists of the routers 102a through 102p and connection links 103a through 103x. As an example, data created by node #0 (101) may be transferred to node #1 (101b) through router #0 (102a), connection link 103a, and router #1 (102b).

Each of the nodes 101a through 101p may generate a first type of data and/or a second type of data. An example of the first type of data is described with reference to FIG. 2.

Referring to FIG. 2, the first type of data 200 includes a plurality of packets 201a through 201n that may be transferred independently. In this example, packets 201a through 201n have predetermined header information 202a through 202n. The header information (for example, of packet 202a) may include a destination address of the corresponding packet (for example 201a). For example, if a message is expressed as the first type of data 200, the message may be segmented into the plurality of packets 201a through 201n, and each of the packets 201a through 201n may be transferred independently according to its respective header information.

According to an aspect, the first type of data 200 may be a packet switching-based message. In various examples, “packet switching” refers to a communication method of segmenting data into predetermined units (for example, packets) and transferring the segmented units independently. In the case of packet switching, a transfer link is occupied temporarily while data is transferred therethrough. In this aspect, the first type of data 200 may be transferred dynamically according to a packet switching method, without using a dedicated path through the network illustrated in FIG. 1.

An example of the second type of data 300 is described with reference to FIG. 3.

Referring to FIG. 3, the second type of data 300 includes a plurality of sub data 301a through 301n that can be logically distinguished from each other. For example, only sub data 301a from among the sub data 301a through 301n has predetermined header information 310. The header information 310 may include a destination address of the corresponding data, for example, the second type of data 300 which includes data 301a through 301n. For example, if a message is expressed as the second type of data 300, the message may be segmented into a plurality of sub data 301a through 301n, and the sub data 301a through 301n may occupy a path through which the second type of data 300 may be transferred.

According to an aspect, the second type of data 300 may be a circuit switching-based message. The circuit switching refers to a communication method of transferring data based on a one-to-one connection that is established between a transmitter and a receiver. In the case of circuit switching, a transfer link is occupied even when no data is transferred. That is, the second type of data 300 may be transferred statically according to the circuit switching method, through a predetermined dedicated path in the network illustrated in FIG. 1.

According to another aspect, the second type of data 300 may include a dedicated path setup request field 303 and a dedicated path setup release field 304. For example, a link through which the data is transferred may not be used transfer other data until all data from the dedicated path setup request field 303 to the dedicated path setup release field 304 is transferred.

In the examples of FIGS. 2 and 3, data 200 and 300 include bit areas 203 and 303 for representing a data type. For example, the first type of data 200 and the second type of data 300 may be distinguished from each other according to values of predetermined circuit setup enable bits 203 and 303. The circuit setup enable bits 203 and 303 may be set by a node (for example, 101a of FIG. 1) that generates the corresponding data 200 and 300. For example, node 101a that generates the corresponding data 200 and 300 may set the corresponding circuit setup enable bits 203 and 303 to 0 or 1 according to a request from an application being executed or according to the characteristic of the application. As an example, if there is a request from a real-time application, the node 101a may set the circuit setup enable bits 203 and 303 to 1 to thereby create the second type of data 300.

In the examples of FIGS. 2 and 3, the data types may be distinguished according to bit values, however, this is only for purposes of example. Accordingly, it should be appreciated that various methods may be used to distinguish data types. For example, in FIG. 3, it is possible that the bit area 303 is removed and the header information 310 of the first sub data 301a performs the function of the bit area 303.

Referring again to FIG. 1, each of the nodes 101a through 101p may generate a first type of data (for example, 200 of FIG. 2) or a second type of data (for example, 300 of FIG. 3) according to a request from an application being executed or according to the characteristic of the application. The type of data to be created may be defined in advance according to a request from the application or according to the characteristic of the application. For example, a method of setting a first type of data to default and creating a second type of data may be used.

In FIG. 1, each of the routers 102a through 102p may transfer a first type of data based on packet switching, and a second type of data based on circuit switching. For example, if the second type of data is transferred, a path between a source node (for example, 101a) that created the second type of data, and a destination node (for example, 101g) that receives the second type of data, may be established as a dedicated path for the second type of data. Accordingly, the second type of data may be transferred through the established dedicated path.

For example, a first type of data may be transferred from the node #0 (101a) to the node #6 (101g), and the first type of data may be default data in the chip multi processor. In this example, node #0 (101a) that has created the first type of data (hereinafter, referred to as data A) may transfer a first packet of the data A to router #0 (102a) which is connected to node #0 (101a). Router #0 (102a) may determine a link through which the data A will be transferred, according to header information of the received packet. For example, in response to router #0 (102a) determining a link connected to router #1 (102b), router #0 (102a) may transfer the packet to router #1 (102b) through the link. As another example, router #1 (102b) that has received the packet may transfer the packet to router #5 (1020 according to the packet switching method. Then, router #5 may transfer the received packet to router #6 (102g) and router #6 (102g) may transfer the received packet to node #6 (101g) which is connected to router #6 (102g).

In this example, the links between routers #0 and #6 (102 and 102g), that is, the links 103a, 103e, and 103i are not dedicated paths for the first type of data that has been created by node #0 (101a). In other words, if another first type of data (hereinafter, referred to as data B) is created in node #0 (101a) before the remaining packets of the data A are transferred, the data B may partially use the links (that is, 103a, 103e, 103i) between router #0 (102a) and router #6 (102g).

As another example, a second type of data may be transferred from node #0 (101a) to node #6 (101g). As an example, the second type of data may be a data type generated in response to an application requiring real-time processing being executed in the chip multi processor 100. Node #0 (101a) that created the second type of data (hereinafter, referred to as data C) may transfer first sub data (or head tilt) of the entire data to router #0 (102a) connected to node #0. Router #0 (102a) may determine a link through which the received sub data will be transferred.

For example, if router #0 (102a) determines the link 103a connected to the router #1 (102b), router #0 (102a) may transfer the sub data to router #1 (102b) and establish the connection link 103a between router #0 (102a) and router #1 (102b) as a dedicated path for the data C. Likewise, router #1 (102b) that receives the sub data may transfer the sub data to router #5 (102f) according to the circuit switching method, and establish the corresponding link 103e as a dedicated path. In this example, the links (that is, 103a, 103e, and 103i) between router #0 (102a) and router #6 (102g) are established as dedicated paths for data C, and the remaining sub data may be transferred through the dedicated paths.

In this example, the links (that is, 103a, 103e, and 103i) between router #0 (102a) and router #6 (102g) are dedicated paths for the second type of data that has been created in node #0 (101a). In other words, in response to first sub data of data C being transferred to establish a dedicated path, another second type of data may not use the links (that is, 103a, 103e, and 103i) between the router #0 (102a) and the router #6 (102g) until the remaining sub data is all transferred.

Accordingly, the chip multi processor 100 may use a packet switching-based network and a circuit switching-based network selectively according to a data type.

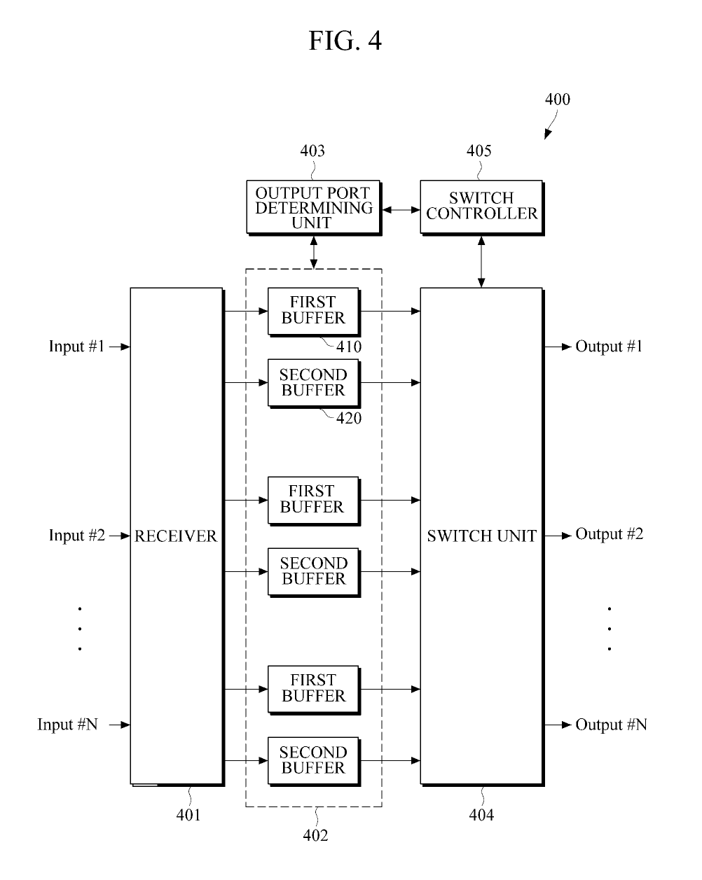

FIG. 4 illustrates an example of a router.

Referring to FIG. 4, router 400 is an example of the routers 102a through 102p described herein with reference to FIG. 1. In this example, router 400 includes a receiver 401, a storage 402, an output port determining unit 403, a switch unit 404, and a switch controller 405.

The receiver 401 may determine whether received data is a first type of data or a second type of data. For example, the receiver 401 may determine a data type based on a specific bit value that is written in a data area of received data. If the received data is determined to be a first type of data, the receiver 401 may transfer the first type of data to a first buffer 410 of the storage 402, and if the received data is determined to be a second type of data, the receiver 401 may transfer the second type of data to a second buffer 420 of the storage 402.

In this example, the storage 402 includes the first buffer 410 for the first type of data and the second buffer 420 for the second type of data.

The output port determining unit 403 may determine an output port through which data stored in the storage 402 is output. For example, the output port determining unit 403 may determine a direction in which data is output, by referring to a predetermined routing table or based on predetermined compile configuration information.

The switch unit 404 may transfer data stored in the storage 402 to an output port based on a determination of the output port determining unit 403. For example, the switch unit 404 may be a crossbar switch. For example, the number of input lines may be m and the number of output lines may be n. Accordingly, the crossbar switch may control connections between arbitrary input and output lines, that is, (m×n) connection combinations with (m+n−1) control devices. In this example, configuration information of the crossbar switch may be stored in the switch controller 405.

The switch controller 405 may control the switch unit 404. The switch controller 405 may change a connection state of the switch unit 404. For example, when the switch unit 404 transfers a first type of data from the first buffer 410, the switch controller 405 may allocate a link connected to an output port to the data temporarily while the data is being transferred. When the switch unit 404 transfers a first type of data from the first buffer 410, the switch controller 405 may cause the switch unit 404 to transfer the first type of data based on the packet switching method.

As another example, when the switch unit 404 transfers a second type of data from the second buffer 420, the switch controller 405 may allocate a link connected to an output port as a dedicated link to the second type of data until the data is completely transferred. That is, when the switch unit 404 transfers a second type of data from the second buffer 420, the switch controller 405 may transfer the data based on the circuit switching method.

As another example when a determined output port is connected to a destination node to receive a second type of data, the switching controller 405 may generate a dedicated path setup success message. The dedicated path setup success message may be transferred to a source node, and the source node which has received the dedicated path setup success message may receive/transfer data from/to the destination node through the corresponding dedicated path according to the circuit switching method.

As another example, when a link connected to the determined output port is allocated another second type of data, the switch controller 405 may generate a dedicated path setup failure message or a standby message.

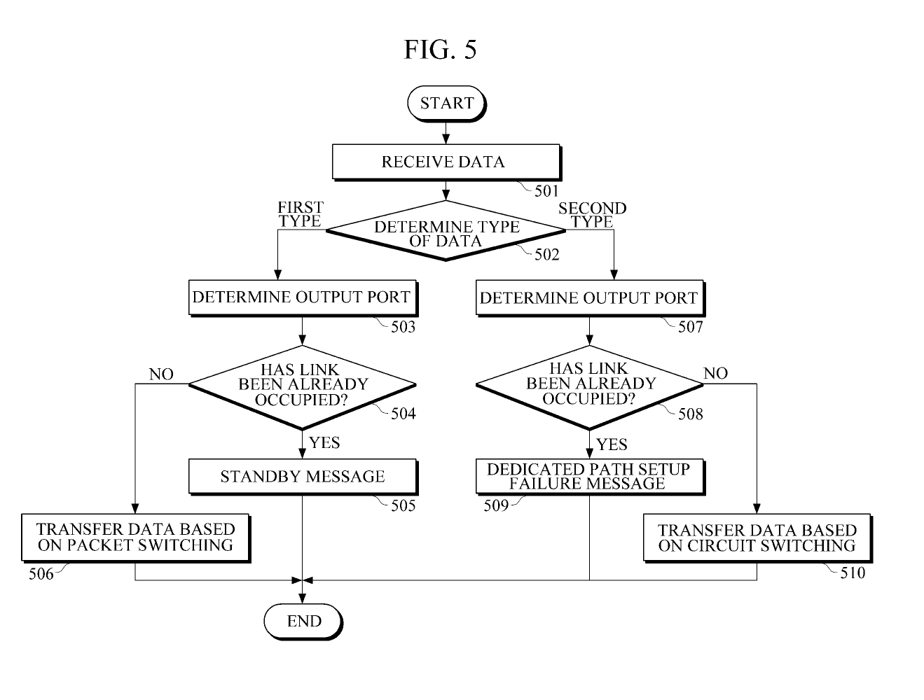

FIG. 5 illustrates an example of a routing method.

Referring to FIG. 5, data is received by the router (501), and a type of the received data is determined (502).

If the received data is a first type of data, the router determines an output port of a packet (503). Next, the router determines whether a link connected to the determined output port is occupied (504). If the link is already occupied, the router generates a standby message instructing “wait until the occupied state is terminated” (505). If the link is not occupied, the router transfers the data through the link based on packet switching (506).

If the received data is a second type of data, the router determines an output port of sub data (507). Next, the router determines whether a link connected to the determined output port is occupied (508). If the link is already occupied, the router generates a dedicated path setup failure message (509). If the link is not occupied, the router establishes a dedicated path and then transfers the data through the dedicated path according to circuit switching (510).

According to various aspects, data communication in a chip multi processor is performed by an optimal switching method that is selected based on a request from an application that is currently being executed or that is suitable for the characteristic of the application. Accordingly, a network bandwidth can be effectively used.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of is computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A computing system or a computer may include a microprocessor that is electrically is connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A chip multi processor comprising:
a plurality of nodes each comprising at least one of a processor and a memory;
a plurality of routers respectively connected to the plurality of nodes; and
a plurality of links formed between the routers,
wherein each router transfers a first type of data based on packet switching and a second type of data based on circuit switching.

2. The chip multi processor of claim 1, wherein each node differentiates a value written in a specific area of data based on a request from an application or based on a characteristic of the application, to create the first type of data or the second type of data.

3. The chip multi processor of claim 1, wherein, in response to transferring the is second type of data, the plurality of routers establish a path between a source node that has generated the second type of data and a destination node that receives the second type of data, as a dedicated path for the second type of data.

4. The chip multi processor of claim 1, wherein each router comprises:
a first buffer configured to store the first type of data;
a second buffer configured to store the second type of data;
an output port determining unit configured to determine an output port through which the first type of data or the second type of data is to be output;
a switch unit configured to transfer the first type of data or the second type of data stored in the first buffer or the second buffer to the determined output port; and
a switch controller configured to establish a link connected to the determined output port as a dedicated link for the second type of data.

5. The chip multi processor of claim 4, wherein each router further comprises a receiver configured to determine whether received data is the first type of data or the second type of data, to transfer the first type of data to the first buffer, and to transfer the second type of data to the second buffer.

6. The chip multi processor of claim 4, wherein the output unit comprises a crossbar switch.

7. The chip multi processor of claim 4, wherein, in response to the determined is output port being connected to a destination node for the second type of data, the controller generates a predetermined dedicated path setup success message.

8. The chip multi processor of claim 4, wherein, in response to the link connected to the determined output port already being allocated to another second type of data, the controller generates a predetermined dedicated path setup failure message or a standby message.

9. A router for a chip multi processor, the router comprising:
a first buffer configured to store a first type of data;
a second buffer configured to store a second type of data;
an output port determining unit configured to determine an output port through which the first type of data or the second type of data is to be output;
an output unit configured to output the first type of data or the second type of data to the determined output port; and
a controller configured to establish a dedicated link connected to the determined output port for the second type of data.

10. The router of claim 9, further comprising:
a receiver configured to determine whether the received data is the first type of data or the second type of data, to transfer the first type of data to the first buffer, and to transfer the second type of data to the second buffer.

11. The router of claim 9, wherein the output unit includes a crossbar switch.

12. The router of claim 9, wherein, in response to the determined output port being connected to a destination node of the second type of data, the controller generates a predetermined dedicated path setup success message.

13. The router of claim 9, wherein, in response to a link connected to the determined output port already being allocated to another second type of data, the controller generates a predetermined dedicated path setup failure message or a standby message.

14. The router of claim 9, wherein the first type of data corresponds to a message that is transferred based on packet switching, and the message includes a plurality of packets each having header information and which are capable of being transferred independently.

15. The router of claim 9, wherein the second type of data corresponds to a message that is transferred based on circuit switching, and the message has single packet with header information.

16. A chip multiprocessor, comprising:
a plurality of processing nodes configured to process data;
a plurality of routers configured to route data between the plurality of processing nodes during processing,
wherein the plurality of routers selectively configure as a packet switching network and as a circuit switching network, based on the type of data to be routed.

17. The chip multiprocessor of claim 16, wherein, in response to a first type of data being processed, the plurality of routers configure as the packet switching network in which a path between a source router and a destination router is shared during transmission of the first type of data between the source router and the destination router.

18. The chip multiprocessor of claim 16, wherein, in response to a second type of data being processed, the plurality of routers configure as the circuit switching network in which a path between a source router and a destination router is not shared during transmission of the second type of data between the source router and the destination router.

19. The chip multiprocessor of claim 18, wherein the second type of data corresponds to an application that requests real-time processing.
